(19) United States
(12) Patent Application Publication
(10) Pub. No.: US 2017/0017882 A1
(43) Pub. Date: Jan. 19, 2017

(54) COPULA-THEORY BASED FEATURE SELECTION

(71) Applicant: FUJITSU LIMITED, Kawasaki-shi (JP)

(72) Inventors: Dawei HE, San Jose, CA (US); Wei-Peng CHEN, Fremont, CA (US)

(21) Appl. No.: 14/797,710

(22) Filed: Jul. 13, 2015

(51) Int. Cl. G06N 5/02

(52) U.S. Cl. CPC G06N 5/02

(57) ABSTRACT

A method of selecting input features may include identifying a first input feature from an input feature set stored in an electronic data storage device. The method may also include generating, by a processor, a first copula to model a dependence structure between the first input feature and an output variable. The method may further include determining a first dependence degree between the first input feature and the output variable based on the first copula. The input feature set may include a second input feature with a second dependence degree having a lower value relative to the first dependence degree. The method may include selecting, by the processor, the first input feature from the input feature set in response to the first dependence degree being greater than the second dependence degree.

### FIELD

The embodiments discussed herein are related to copula theory-based feature selection.

### BACKGROUND

Feature selection is often used to improve data modeling techniques. Feature selection is typically referred to as a process of selecting a subset of relevant features for use in data modeling. While many input features in an input feature set may be available for data modeling, some of the input features in the input feature set may be more relevant to an output of a data model than other features. In addition, some input features may be redundant. To provide greater accuracy in the data model, the input features that influence the output may be used in the data model while the redundant or non-relevant input features may be excluded without much information loss.

Determining which input features are relevant to the output of the data model may be challenging. Some input feature selection algorithms are based on correlation analysis that rely on linear relationships between input features. Some feature selection techniques, however, may have difficulty measuring non-linear relationships between features. In addition, many input features may change over time, making it ever more difficult for such feature selection techniques to accurately understand a relationship between input features. Moreover, such feature selection techniques may be limited to identifying relationships between features but may not identify dependency between the input features and the output.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of selecting input features may include identifying a first input feature from an input feature set stored in an electronic data storage device. The method may also include generating a first copula to model a dependence structure between the first input feature and an output variable. The method may further include determining a first dependence degree between the first input feature and the output variable based on the first copula. The input feature set may include a second input feature with a second dependence degree having a lower value relative to the first dependence degree. The method may include selecting, by the processor, the first input feature from the input feature set in response to the first dependence degree being greater than the second dependence degree.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example computer system that may implement copula theory-based feature selection;

FIG. 2 is a flow diagram of an example method of copula theory-based feature selection;

FIG. 3 illustrates a flow diagram of a method for determining a copula between an input feature and an output variable;

FIG. 4 is a flow diagram of an example method of dependence degree generation in conjunction with copula theory-based feature selection;

FIG. 5 is a flow diagram of another example method of copula theory-based feature selection; and

FIG. 6 is a block diagram illustrating an example computing device that is arranged for copula theory-based feature selection, all arranged in accordance with at least one embodiment described herein.

### DESCRIPTION OF EMBODIMENTS

Methods and systems disclosed herein allow copula theory-based feature selection to identify relationships between variables in data modeling. Copula theory-based feature selection may be used to model the dependence between one or more input features and one or more output variables. A copula is a function that describes the dependence between random variables. Using a copula, it is possible to determine a dependence structure of random variables without knowing a marginal distribution of the variables. For example, for a random vector (X₁, X₂, . . . , X_{d}), its marginal cumulative distribution functions (CDF), Uᵢ=Fᵢ(x)=P (Xᵢ≦x) (i=1, 2, . . . , d) are continuous functions. According to Sklar's Theorem, the joint CDF of (X₁, X₂, . . . , X_{d}), H(X₁, X₂, . . . , X_{d})=P(X₁≦x₁, . . . , X_{d}≦x_{d}) may be represented as H(x₁, . . . , x_{d})=C(F₁(x₁), . . . , F_{d}(x_{d}))=C(u₁, . . . , u_{d}), where function C is defined as the copula of (X₁, X₂, . . . , X_{d}) and H is the joint CDF. Sklar's theorem also states that, given H, the copula C is unique. Thus, each unique copula may be used to determine relative dependence of an input feature (or set of input features) to an output variable.

Using copulas for input feature selection may provide various advantages. For example, the feature selection techniques disclosed herein may consider both the dependence between each input feature (feature-to-feature dependence) as well as the dependence between the input features with one or more output variable (feature-to-output dependence). For example, copulas may be used to build a variety of dependence structures based on parametric or non-parametric models of marginal distributions which may provide a more accurate mathematical expression of the relationship between one or more input features and one or more output variables as compared to some other methods. Another advantage is the relative mathematical simplicity of copula theory in describing the features without calculating a joint-CDF as may be done under some other methods. Thus, copula theory-based feature selection may identify input features that are relevant to the output variable of a data model.

In some embodiments, copula theory-based feature selection may use a parametric model and historical data pertaining to relationships between the features to identify relationships between the one or more input features and the one or more output variables. In other embodiments, where historical data is not available, copula theory-based feature selection may use a non-parametric model to identify relationships between features themselves first, then use those relationships between features to identify relationships between the input features and the output variable. Once these relationships are known, a feature selection system may identify relevant input features which may be used to generate a data model. The input feature selection techniques described herein may include a searching algorithm to search the highest dependence degree input feature set to overcome the order in which input features are added to a dynamically increasing temporary feature set. For example, the searching algorithm may start from a generic algorithm with a temporary feature set and may update the temporary feature set as part of feature selection. For example, one temporary feature in the temporary feature set may be randomly substituted by another feature in the feature set to be studied during feature selection process. In some embodiments, the temporary feature may provide better results during the feature selection process and that temporary feature may be added to the input feature set. Since copula theory-based feature selection has better capability to identify relationships between variables as compared to some other techniques, copula theory-based feature selection may also result in more accurate data models. These and other embodiments are described with reference to the appended drawings.

Copula theory-based feature selection may be used for data modeling in any field. Accordingly, some embodiments discussed herein include a framework for real-time price forecasting. For example, a real-time electricity price forecast for different regions and different utility providers (e.g., CAISO, ERCOT, NYISO, etc.) may be influenced by various features, such differences in power generation, customer composition, local weather, infrastructure, etc. Therefore, the disclosed copula theory-based feature selection techniques may be beneficial because they may be adaptive to constant changes with respect to input variables.

Other embodiments discussed herein may include a framework for residential electricity load identification and classification. For example, an identifier or classifier for residential load sets may be updated frequently because of constant changes in consumer electronic products that are connected to a home electrical system. For load identification, different loads may have different dominant input features. For example, a startup transient waveform of television may be relevant for televisions but not relevant for other electronic products. Each electronic product may have different input features that contribute to the residential load in different ways. Some electronic products may have an identical input feature that is relevant to the residential load for one electronic product but not for another. Thus, it may be desirable to identify specific dominant input feature set(s) for different loads (e.g., for each different electronic products within a home). To identify specific dominant input feature set(s) for different loads, the techniques described herein may identify relationships between the input features with output instead of and/or in addition to determining relationships among the input features independent of the output.

In the following description, details are set forth by way of example to facilitate discussion of the disclosed subject matter. The disclosed embodiments are provided by way of example only and are not exhaustive of all possible embodiments. Some embodiments will be explained with reference to the accompanying drawings.

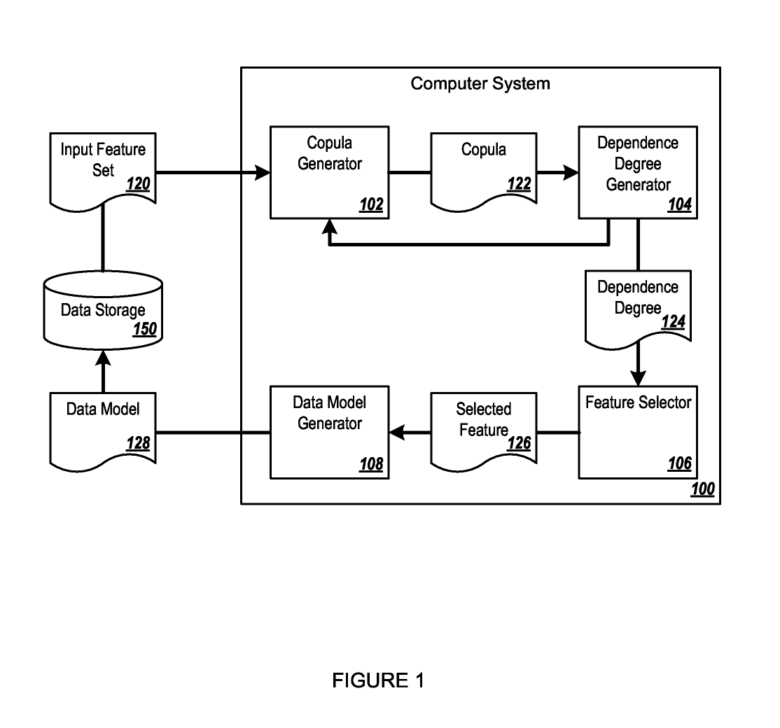

FIG. 1 illustrates a block diagram of an example computer system 100 that may implement copula theory-based feature selection, arranged in accordance with at least one embodiment described herein. For example, the computer system 100 may determine a relationship between an input feature and an output variable. The computer system 100 depicted in FIG. 1 may include a copula generator 102, a dependence degree generator 104, a feature selector 106, and a data model generator 108.

The computer system 100 may include a hardware server that includes a processor, a memory, and network communication capabilities. In some embodiments, the computer system 100 may be implemented using hardware including a field-programmable gate array (FPGA) or an application-specific integrated circuit (ASIC). In some other instances, the computer system 100 may be implemented using a combination of hardware and software.

In the computer system 100, data sets including input feature data, relationship data, or portions thereof as well as other messages and information may be communicated between the computer device and a data storage 150. The computer system 100 may be operatively coupled to the data storage 150. For example, the data storage 150 may be hard wired to the computer system 100. In other embodiments, the data storage 150 may be in data communication with the computer system 100 over a network (not shown). The network may be wired or wireless, and may have numerous configurations including a star configuration, token ring configuration, or other configurations. The network may include a local area network (LAN), a wide area network (WAN) (e.g., the Internet), and/or other interconnected data paths across which multiple devices may communicate. In some embodiments, the network may include a peer-to-peer network. The network may also be coupled to or include portions of a telecommunications network that may enable communication of data in a variety of different communication protocols. In some embodiments, the network may include BLUETOOTH® communication networks and/or cellular communication networks for sending and receiving data via short messaging service (SMS), multimedia messaging service (MMS), hypertext transfer protocol (HTTP), direct data connection, wireless application protocol (WAP), e-mail, etc. The data storage 150 may be included in the computer system 100 or may be separate from the computer system 100.

The data storage 150 may include a removable storage device, a non-removable device, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data. In some embodiments, the data storage 150 includes a relational database and each input feature and its respective copula 122 and dependence degree 124 is stored in the data storage 150 in association with the output variable. For example, when dependence degrees are generated for three different input features with respect to a particular output variable, the three different input features and their respective dependence degrees may be stored in association with the particular output variable.

In the computer system 100, the copula generator 102 may identify an input feature set 120 from the data storage 150. The input feature set 120 may include any number of features and may include an entire data set or a subset of the data set. For example, in an electricity price prediction model, where the output is a predicted electricity price, the input feature set 120 may include time-related input features (e.g., seasons, weekday/weekend, hour), load-related input features (e.g., spike, load, differences between real-time load and forecasted load), price-related input features (e.g., price for the past hour, day ahead market clearing price, price of same time yesterday, variation of the price within the past hour), location-related input features (e.g., transmission capacity, zonal demand amount), and other input features (e.g., spike series length, elastic electricity demand, demand price ratio). These input features (and others) may affect the predicted electricity price in different ways that may also vary based on time. The computer system 100 may identify a relationship between these input features and the predicted electricity price (e.g., the output variable) and may select relevant input features to use to predict the electricity price while excluding non-relevant and/or redundant input features. In some embodiments, the input feature set 120 is defined by a system administrator. In some embodiments, the input feature set 120 may include a set of features that were previously determined to be relevant to a particular output variable. For example, the computer system 100 may have performed a large number of data models to identify key input features to a predicted electricity price. If, for example, an input feature has a strong relationship in a threshold number of those data models, then that input feature may be marked to be used in each subsequent data model to predict the electricity price. In some embodiments, marked input features may be unmarked, such as by a system administrator or automatically after a threshold number of data models have been generated that do not use the marked input feature.

The copula generator 102 may identify an input feature in the input feature set 120 and may use the input feature to generate a copula 122 to model a dependence structure between the input feature and an output variable. For example, in an electricity price prediction model, the copula generator 102 may identify “spike” as the input feature and may generate a copula using the spike data and the electricity price. In some embodiments, the copula of Xᵢ may be represented as (X₁, X₂, . . . , X_{d}). The copula generator 102 may store the generated copula 122 in the data storage 150.

The dependence degree generator 104 may use the copula 122 to determine a dependence degree 124 between the input feature and the output variable based on the copula 122. The dependency degree may include an alphanumeric representation of the relationship between the input feature and the output variable. The dependency degree may include different alphanumeric values that may represent a scale of increasing or decreasing dependency. For example, a dependency degree may include one of ten possible degrees, 1-10, where 1 is a lowest value that represents a non-relevant relationship between the input feature and the output feature and where 10 is a highest value that represents a relevant relationship between the input feature and the output feature. In other embodiments, the dependency degree is binary, with one binary value indicating relevancy and the other binary value indicating non-relevancy between the input feature and the output variable. Continuing the electricity price prediction model example from above, the dependence degree generator 104 may use the spike copula 122 to determine a dependence degree between the spike copula 122 and the electricity price. In some embodiments, the dependence degree generator 104 stores the dependence degree 124 in the data storage 150.

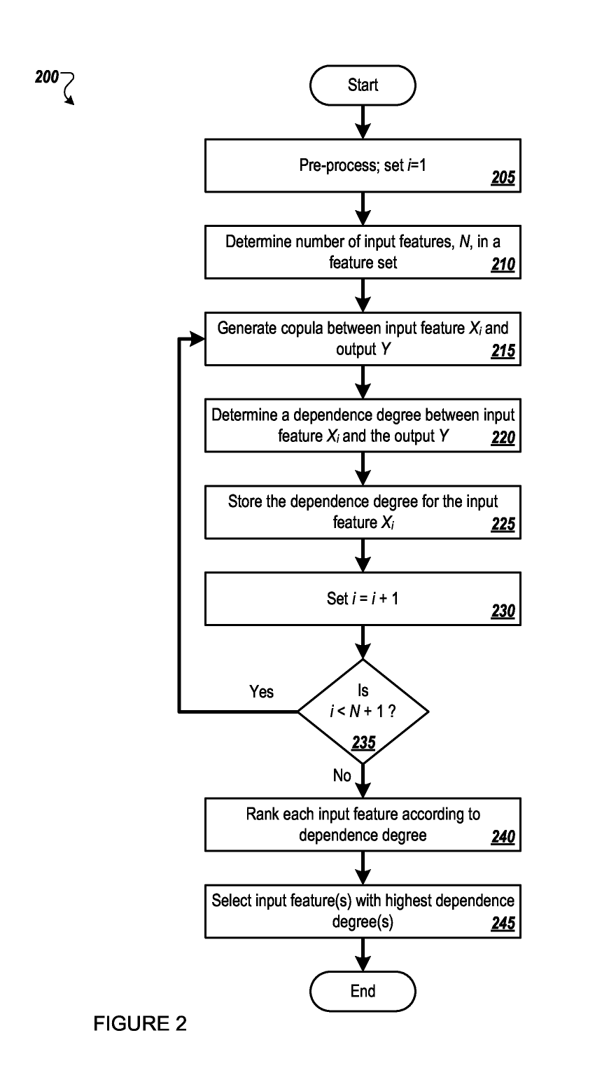

In some embodiments, the input feature set 120 includes multiple input features. In such embodiments, the copula generator 102 may estimate a copula 122 between each input feature in the input feature set 120. Similarly, the dependence degree generator 104 may generate a dependence degree 124 for each input feature in the input feature set 120 using the respective copula 122. The copula generator 102 may also estimate a copula 122 between the input feature set 120 or a subset of the input feature set 120 and the output variable. The dependence degree generator 104 may generate a dependence degree 124 for each copula 122 that was generated between the input feature set 120 or a subset of the input feature set 120 and the output variable. Copula generation is further described in conjunction with FIGS. 2, 3 and 5. Dependence degree generation is further described in conjunction with FIGS. 2, 4 and 5.

When each dependence degree has been generated for each input feature in the input feature set 120 (or the subset of the input feature set 120), the feature selector 106 may select one or more input features based on their respective dependence degrees. The feature selector 106 may use any selection criteria when selecting the one or more input features. In some embodiments, the feature selector 106 selects all input features with a dependence degree that is above a threshold value. In some embodiments, the feature selector 106 selects a threshold number of input features based on their dependence degree. For example, the feature selector 106 may select input features with the five (or some other number) highest dependence degrees, or all input features that have a dependence degree greater than a threshold dependence degree, or may otherwise use the dependence degrees of the input features to determine which input features to select.

The data model generator 108 may use the selected features to create a data model for the output variable. In light of the feature selection operations performed prior to data model generation, the data model generator 108 may provide a highly accurate data model because it was generated using features that were relevant to the output variable. Further, data model generation may be more efficient than some other methods because the data model generator 108 may not use all of the input features to generate a data model. Fewer input features may mean fewer resources (e.g., processor, memory resource) may be used for data model generation. Accordingly, and compared to some other methods, embodiments described herein may improve processing speed of the computer system 100 or otherwise improve the functioning of the computer system 100 by, e.g., reducing consumption of processor and/or memory resources since not all of the input features may be used to generate the data model.

Moreover, some embodiments may be applicable in other systems or environments. While the computer system 100 depicted in FIG. 1 includes copula theory-based feature selection and data modeling, the computer system 100 is a particular example of an environment in which features may be selected at least in part using a copula as described herein. An example environment of price forecasting in which copula theory-based feature selection techniques may be implemented has been described. Alternatively, processes similar or identical to those described herein may be used for copula theory-based feature selection in environments in which there are multiple input features with potentially complex interrelationships, such as electricity load, weather forecasting, non-intrusive load classification and identification, human behavior analysis based on smart sensor data, renewable energy forecasting, customer classification, and the like.

Modifications, additions, or omissions may be made to the computer system 100 without departing from the scope of the present disclosure. For example, embodiments depicted in FIG. 1 include one copula generator 102, one dependence degree generator 104, one feature selector 106, one data model generator 108, and one data storage 150. However, the present disclosure applies to systems that may include one or more copula generator 102, one or more dependence degree generator 104, one or more data model generator 108, one or more one data storage 150, or any combination thereof. As another example, the copula generator 102, dependence degree generator 104, feature selector 106, data model generator 108 and/or the data storage 150 may be implemented as a server while one or more client devices may supply one or more features of the input feature set 120 and/or may receive the data model 128.

Moreover, the separation of various components in the embodiments described herein is not meant to indicate that the separation occurs in all embodiments. It may be understood with the benefit of this disclosure that the described components may be integrated together in a single component or separated into multiple components.

FIGS. 2-5 are flow diagrams of various methods related to copula theory-based feature selection. The methods may be performed by processing logic that may include hardware (circuitry, dedicated logic, etc.), software (such as is run on a general purpose computer system or a dedicated machine), or a combination of both, which processing logic may be included in the computer system 100 or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods could alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. The methods illustrated and described in conjunction with FIGS. 2-5 may be performed, for example, by a system such as the computer system 100 of FIG. 1. For clarity of presentation, the description that follows uses the computer system 100 as examples for describing the methods. However, another system, or combination of systems, may be used to perform the methods.

FIG. 2 is a flow diagram of an example method 200 of copula theory-based feature selection, arranged in accordance with at least one embodiment described herein. The method 200 may begin at block 205 where the processing logic performs pre-processing. As part of the pre-processing, the processing logic may reset any counters. For example, the processing logic may reset a counter, i, to i=1. At block 210, the processing logic may determine a number of input features, N, in an input feature set. Any number of features may be included in the input feature set, as described herein. The processing logic may store the number of features in the input feature set in a data storage, such as the data storage 150 of FIG. 1.

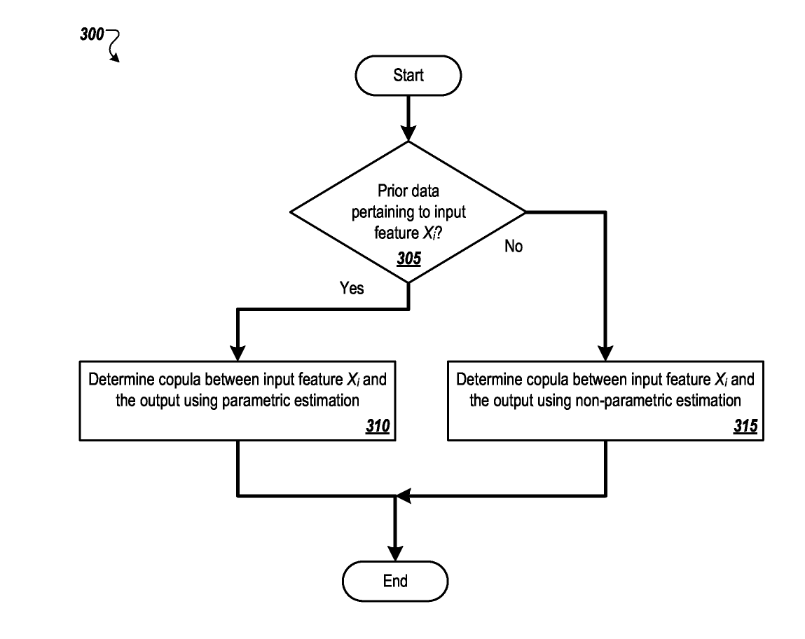

At block 215, the processing logic may generate a copula to model a dependence structure between an input feature, Xᵢ, and an output variable, Y. Some or all of the method 200 may be iterative such that when i=1, block 215 may include the processing logic generating a first copula to model a dependence structure between a first input feature, Xᵢ, and the output variable, Y. Generating the first copula may include identifying the first input feature Xᵢ in an input feature set. The processing logic may use any suitable technique(s) to generate the first copula. In some embodiments, the processing logic may use parametric estimation techniques when prior data pertaining to the input feature set are available or non-parametric estimation techniques when prior data pertaining to the input feature set are not available, as further described in conjunction with FIG. 3. The processing logic may store the copula in a data storage, such as the data storage 150 of FIG. 1.

At block 220, the processing logic determines a first dependence degree between the first input feature Xᵢ and the output variable Y based on the first copula. At block 225, the processing logic stores the first dependence degree for the input feature Xᵢ and the output variable Yin a data storage, such as data storage 150 of FIG. 1.

At block 230, the processing logic increments the counter, i, by one (e.g., sets i=i+1). At block 235, the processing logic determines whether the counter, i, is less than the number of input features, N, in the input feature set plus one (e.g., is i<N+1 ?). When i is less than N+1 (e.g., “YES” at block 235), the processing logic may loop to block 215 to determine dependence degrees for a next or another input feature in the input feature set. The processing logic may perform this forward traversal until it has determined copulas and dependence degrees for each input feature in the input feature set.

After the processing logic determines dependence degrees for each input feature in the input feature set (e.g., “NO” at block 235), at block 240, the processing logic optionally may rank each input feature according to their respective dependence degrees. For example, the processing logic may numerically rank the dependence degrees in reverse or descending numerical order, such that the dependence degrees with the highest values are ranked highest. For example, the processing logic may assign each dependence degree with a numerical rank and store the rank in association with the respective input feature in an electronic data storage device. In some embodiments, the processing logic may mark some input features as “inactive,” such that the input features marked as inactive are not to be used as input features in data models generated for the output variable. In some embodiments, the processing logic may discard input features that have dependence degrees that are below a minimum threshold value.

At block 245, the processing logic selects one or more input features based on the determined dependence degrees. For example, the processing logic may select at least a highest-ranked input feature, e.g., the input feature that corresponds to the highest dependence degree, in response to its numerical rank being higher than other dependence degrees of other input features. In some embodiments, the processing logic may generate a data model for the output using the selected one or more input features. In other embodiments, the processing logic sends the selected one or more input features to a data model generator for subsequent data model generation.

FIG. 3 illustrates a flow diagram 300 of a method for determining a copula between an input feature and an output variable, arranged in accordance with at least one embodiment. Copula theory-based feature selection may vary based on different environments. In some embodiments, a less complex method may be used to determine the copula, such as when an input feature set is under an acceptable size, when a dependence between each feature is not very strong and/or when the dependence between each feature has limited influence on the output variable. This less complex method may focus primarily on identifying known relationships between the features with the output variable. In other embodiments, the processing logic may use a more complex method of copula theory-based feature selection. This more complex method of copula theory-based feature selection may be used when little or nothing is known about the relationships between input features in the input feature set. This second method of copula theory-based feature selection may be used to identify relationships between the input features and output variable as well as the relationship between each feature.

The method 300 may begin at block 305 where processing logic determines whether it has access to prior data pertaining to the input feature Xᵢ. The prior data may relate to a known relationship between the input feature Xᵢ and one or more other input features.

When prior data exists (e.g., “YES” at block 305), at block 310, the processing logic determines a copula between input feature Xᵢ and the output variable using parametric estimation. Parametric estimation may refer to an approach to copula generation where prior knowledge may be applied to the input feature set(s). There are two main families of copulas, Gaussian and Archimedean. Under each family, there are many different types of copula generation techniques, such as t-student and Brownian (both Gaussian) and Clayton or Gumbel (both Archimedean). These different types of copulas may be applied for different situations. For example, a Brownian copula may be used in price forecasting.

When prior data does not exist (e.g., “NO” at block 305), at block 315, the processing logic determines a copula between input feature Xᵢ and the output variable using non-parametric estimation. Non-Parametric Estimation may refer to a copula generation technique where no prior-knowledge is provided for the input feature set. For example, when studying multivariate data, one may investigate the underlying copula. Suppose we have observations (X₁ⁱ, X₂ⁱ, . . . , X_{d}ⁱ), i=1, . . . , n from a random vector (X₁, X₂, . . . , X_{d}) with continuous margins. The corresponding “true” copula observations may be represented as (U₁ⁱ, U₂ⁱ, . . . , U_{d}ⁱ)=(F₁(X₁ⁱ), F₂(X₂ⁱ), . . . , F_{d}(X_{d}ⁱ)), i=1, . . . , n. However, marginal distribution functions Fᵢ are usually not known. Therefore, one may construct pseudo copula observations by using empirical distribution functions

$${F}_{k}^{n} ( x ) = \frac{1}{n} {\sum }_{i = 1}^{n} 1 ( {X}_{k}^{i} \leq x )$$

instead. Then, the pseudo copula observations may be defined as (Ũ₁ⁱ, Ũ₂ⁱ, . . . , Ũ_{d}ⁱ)=(F₁ⁿ(X₁ⁱ), F₂ⁿ(X₂ⁱ), . . . , F_{d}ⁿ(X_{d}ⁱ)), i=1, . . . , n. The corresponding empirical copula may then be defined as

$${C}^{m} ( {u}_{1} , … , {u}_{d} = \frac{1}{n} {\sum }_{i = 1}^{n} 1 ( {\tilde{U}}_{1}^{i} \leq {u}_{1} , … , {\tilde{U}}_{d}^{i} \leq {u}_{d} ) ) .$$

The components of the pseudo copula samples may also be written as Ũₖⁱ=Rₖⁱ/n, where Rₖⁱ is the rank of the observation Xₖⁱ:

$${R}_{k}^{i} = \frac{1}{n} {\sum }_{j = 1}^{n} 1 ( {X}_{k}^{j} \leq {X}_{k}^{i} ) .$$

Therefore, the empirical copula may be seen as the empirical distribution of the rank transformed data.

Parametric Estimation may be used when a distribution of the multi-variables exists. For example, a Gauss Copula is a copula based on a Gauss distribution. The Gaussian copula is a distribution over the unit cube [0,1]^{d}. It is typically constructed from a multivariate normal distribution over [symbol] ^{d} by using the probability integral transform. For a give correlation matrix Rε [symbol] ^{d×d}, the Gaussian copula with parameter matrix R may be written as C_{R}^{Gauss}(u)=Φ_{R}(Φ⁻¹(u₁), . . . , Φ⁻¹(u_{d})), where Φ⁻¹ is the inverse cumulative distribution function of a standard normal and Φ_{R} is the joint cumulative distribution function of a multivariate normal distribution with mean vector zero and covariance matrix equal to the correlation matrix R. The density may be written as

$${C}_{R}^{Gauss} ( u ) = \frac{1}{\sqrt{det R}} exp ( - \frac{1}{2} {( \begin{matrix}{Φ}^{- 1} ( {u}_{1} ) \\ ⋮ \\ {Φ}^{- 1} ( {u}_{d} )\end{matrix} )}^{T} \cdot ( {R}^{- 1} - I ) \cdot ( \begin{matrix}{Φ}^{- 1} ( {u}_{1} ) \\ ⋮ \\ {Φ}^{- 1} ( {u}_{d} )\end{matrix} ) ) ,$$

where I is an identity matrix.

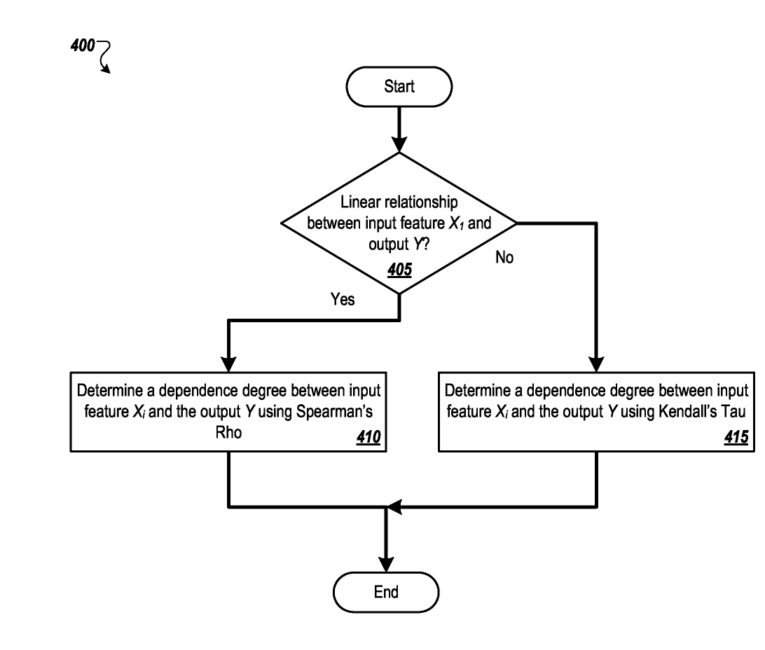

FIG. 4 is a flow diagram of an example method 400 of dependence degree generation in conjunction with copula theory-based feature selection, in accordance with at least one embodiment described herein.

At block 405, processing logic determines whether a relationship between the input feature Xᵢ and the output variable is linear. In some embodiments, the processing logic determines a linear relationship based on a particular application scenario. For example, certain types of applications may be easier to determine a linear relationship, such as a wind speed with wind power in wind power forecasting scenario. Some applications may be non-linear, such as price forecasting, where the relationship of price with load may be an exponential relationship. In an example, typically the linear correlation analysis may be applied to two groups of data to see their relationship. A linear regression may be applied and if hypothesis test is passed, then it may be determined that the two groups of data have a linear relationship. The hypothesis test may use the R-test or other types of hypothesis tests.

When the relationship between the input feature Xᵢ and the output variable is linear (e.g., “YES” at block 405), at block 410 the processing logic determines a dependence degree between the input feature Xᵢ and the output Y using Spearman's Rho. Spearman's Rho may be represented as:

ρ_{S}(X,Y)=12∫₀¹∫₀¹C(u,v)dudv−3, and cor(X,Y)=2 sin(π/6ρ_{S}).

When the relationship between the input feature Xᵢ and the output variable is non-linear (e.g., “NO” at block 405), at block 415 the processing logic determines a dependence degree between the input feature Xᵢ and the output Y using Kendall's Tau. Kendall's Tau may be represented as:

ρ_{τ}(X,Y)=4∫₀¹∫₀¹C(u,v)dC(u,v)−1, and cor(X,Y)=2 sin(π/2ρ_{τ}).

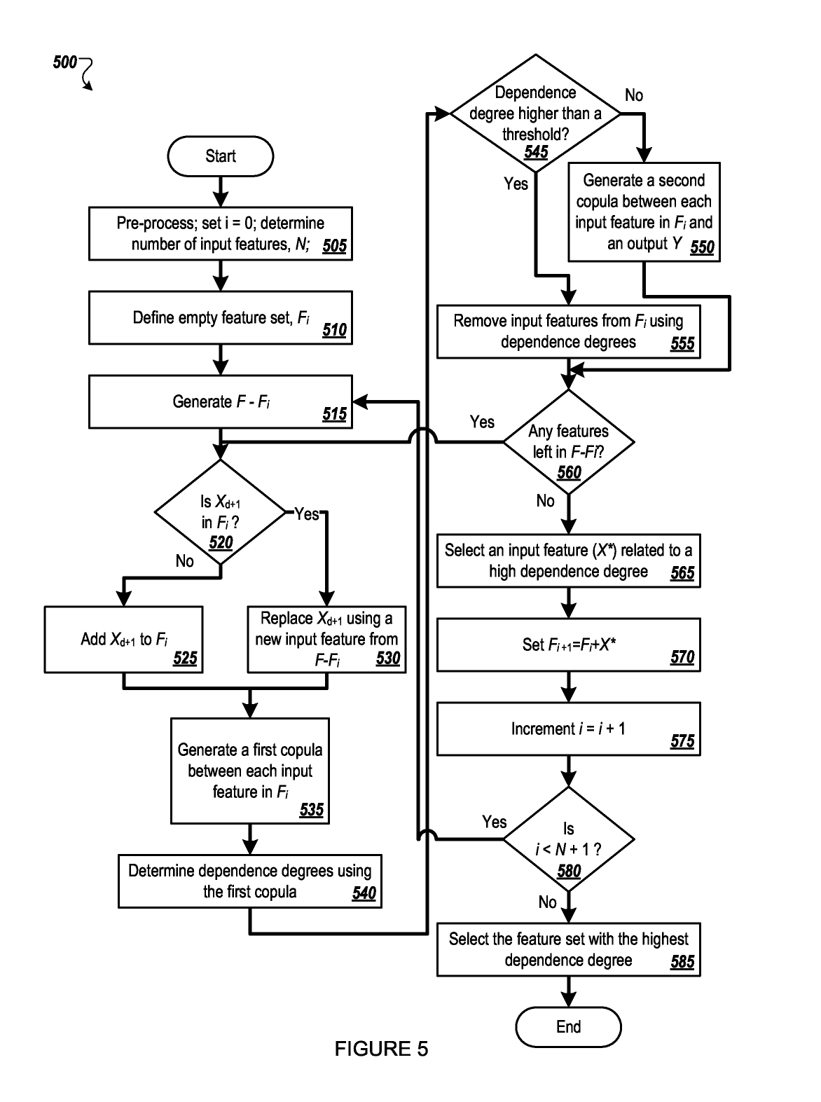

FIG. 5 is a flow diagram of another example method 500 of copula theory-based feature selection, in accordance with at least one embodiment described herein. At block 505, the processing logic performs pre-processing. As part of the pre-processing, the processing logic may reset any counters. For example, the processing logic may reset a counter, i, to i=0. The processing logic may also determine a number of input features, N, in an input feature set. Any number of features may be in the input feature set, as described herein. The processing logic may store the number of features in the input feature set in a data storage, such as data storage 150 of FIG. 1.

At block 510, the processing logic defines an empty input feature set Fᵢ. The empty input feature set Fᵢ may be a temporary feature set. During execution of the method 500, the processing logic may iteratively add input features to Fᵢ and determine a copula for Fᵢ after each new input feature is added.

At block 515, the processing logic generates F−Fᵢ. F is the full feature set. Fᵢ is the selected feature set and initially includes zero features. F−Fᵢ is an unselected feature set.

At block 520, the processing logic determines whether a new input feature, X_{d+1}, is in Fᵢ. When X_{d+1} is not in Fᵢ (e.g., “NO” at block 520), at block 525, the processing logic adds X_{d+1} to Fᵢ. When X_{d+1} is in Fᵢ (e.g., “YES” at block 520), at block 530, the processing logic replaces X_{d+1} using a new input feature from F−Fᵢ.

At block 535, the processing logic may estimate or generate a first copula between each input feature in Fᵢ, which may be represented as C₁, the copula of X_{d+1} with the features (X₁, X₂, . . . , X_{d}). If there is only one input feature in Fᵢ, then no copula may be calculated. One input feature in Fᵢ may mean that the algorithm is in an initialization phase.

At block 540, the processing logic determines dependence degrees between the new input X_{d+1} with each Xᵢ in Fᵢ. The processing logic may also calculate dependence degrees of (X₁, X₂, . . . , X_{d}, X_{d+1}) with Y, as further described in conjunction with FIG. 4.

At block 545, the processing logic may determine whether the dependence degree(s) generated at block 540 are higher than a threshold. The threshold may be any value and may be a predetermine number defined by a system administrator.

When the dependence degree(s) is not higher than the threshold (e.g., “NO” at block 545), at block 550, the processing logic may estimate or generate a second copula between each input feature in Fᵢ and an output variable Y, which may be represented as C₂, the copula of (X₁, X₂, . . . , X_{d}, X_{d+1}) with Y. The processing logic may proceed to block 560, as described below.

When the dependence degree(s) is higher than the threshold (e.g., “YES” at block 545), at block 555, the processing logic removes input features from Fᵢ using the dependence degrees. In some embodiments, when the first copula and the second copula are within a threshold variance from each other (i.e., close in similarity), the processing logic may infer that a dependence between the output variable Y and the input feature added to the input feature set at either block 525 or 530 is not significant. The processing logic may remove any not significant input features from the input feature set, Fᵢ. For example, the processing logic may remove features that have low relationships, dependence degrees or small copula features. When X_{d+1} does not have a high relationship with Y, then that X_{d+1} may not be added to Fᵢ. The processing logic may also remove features from F as described in an example below.

At block 560, the processing logic determines whether there are any input features left in F−Fᵢ. When there are still input features in F−Fᵢ (e.g., “YES” at block 560), the processing logic may add another input feature to Fᵢ, as described in blocks 525 and 530. Thus, the size of Fᵢ may continue to increase as the processing logic loops through blocks 520-560. For each loop, the processing logic may add one more input feature to Fᵢ. For each new Fᵢ, the processing logic may generate additional copulas at blocks 535 and 540. Each different Fᵢ will have its own unique set of copula and dependence degrees that correspond to each copula. For example, the processing logic may generate feature-to-feature copula and feature-to-output variable copula for each input feature set Fi.

When there are no input features in F−Fᵢ (e.g., “NO” at block 560), at block 565, the processing logic selects an input feature X* with a high dependence degree. In some embodiments, the highest dependence degree of the second copula may be selected, with the X_{d+1} added in the input feature set. At block 570, the processing logic adds the selected input feature X* to the input feature set (e.g., Fᵢ₊₁=Fᵢ+X*).

At block 575, the processing logic may increment the counter, i, by one (e.g., sets i=i+1). At block 580, the processing logic determines whether the counter, i, is less than the number of input features, N, in the input feature set plus one (e.g., is i<N+1 ?). When i is less than N+1 (e.g., “YES” at block 580), the processing logic may loop to block 515 to recalculate F−Fᵢ. When i is greater than or equal to N+1 (e.g., “NO” at block 580), at block 585 the processing logic selects one or more input features with the highest dependence degrees, as described herein. In some embodiments, the processing logic discards input features with low dependence degrees, as described herein. The processing logic may store the selected one or more input features, which may be used to generate a data model for the output Y.

In an example, of the operation of the method 500, F={a, b, c, d, e, f, g}, Fᵢ={a, b, c}, and F−Fᵢ={d, e, f, g}. At block 520, the processing logic may add d from F into Fᵢ.

At block 535, the processing logic may calculate the relationship between d with a, b, c by using a copula. At block 540: the processing logic may calculate a dependence degree using the copula. At block 545, the processing logic may determine that d will not be selected (e.g., “YES” at block 545) because it is similar to any of a, b or c, or a combination thereof (e.g., the dependence degree is above the threshold). In some embodiments, d is removed from F. When the dependence degree is below the threshold, (e.g., “NO” at block 545), at block 550: the processing logic may calculate another copula, this time between d and Y(a,b,c).

At block 565, the processing logic may select e from F. At block 520, the processing logic may add e from F into Fᵢ. At block 535, the processing logic may calculate the relationship between e with a, b, c and may generate a copula, C1. At block 540, the processing logic may calculate a dependence degree to determine if e is similar to a, b or c. In the example, the dependence degree for e is below the threshold and at block 550, the processing logic may calculate the relationship between e with Y(a,b,c) and may generate a copula C2. The processing logic may temporarily select e because e is not similar to any one of a, b, c, based on the copula C2. Features f and g still remain in F−Fᵢ so the processing logic selects fat block 565.

At block 520, the processing logic may add f from F into Fᵢ. At block 535, the processing logic may calculate a relationship between f with a, b, c and may generate a copula C3. At block 540, the processing logic may calculate a dependence degree to determine if f is similar to a, b or c. In the example, the dependence degree for f is below the threshold and at block 550, the processing logic may calculate the relationship between f with Y(a,b,c) and may generate a copula C4. At block 545, the processing logic may determine if f is similar to a, b or c. The processing logic may temporarily select f because e is not similar to any one of a, b, c, based on the copula C2 at block 565. The processing logic may perform similar operations for g and may generate copulas C5 and C6.

At block 565, the processing logic may use three copulas C2 for e, C4 for f and C6 for g and then may select the highest copula. For example, C2 may be the highest copula and the processing logic may select e. and add e to Fᵢ such that the new Fᵢ={a,b,c,e}. At block 515, the processing logic may generate F−Fᵢ again, which equals {d, e, f, g}. The processing logic may repeat blocks 520-560 until F−Fᵢ is equal to an empty set or when copulas have been generated for each feature in Fᵢ.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed implementations.

The embodiments described herein may include the use of a special-purpose or general-purpose computer including various computer hardware or software modules, as discussed in greater detail below.

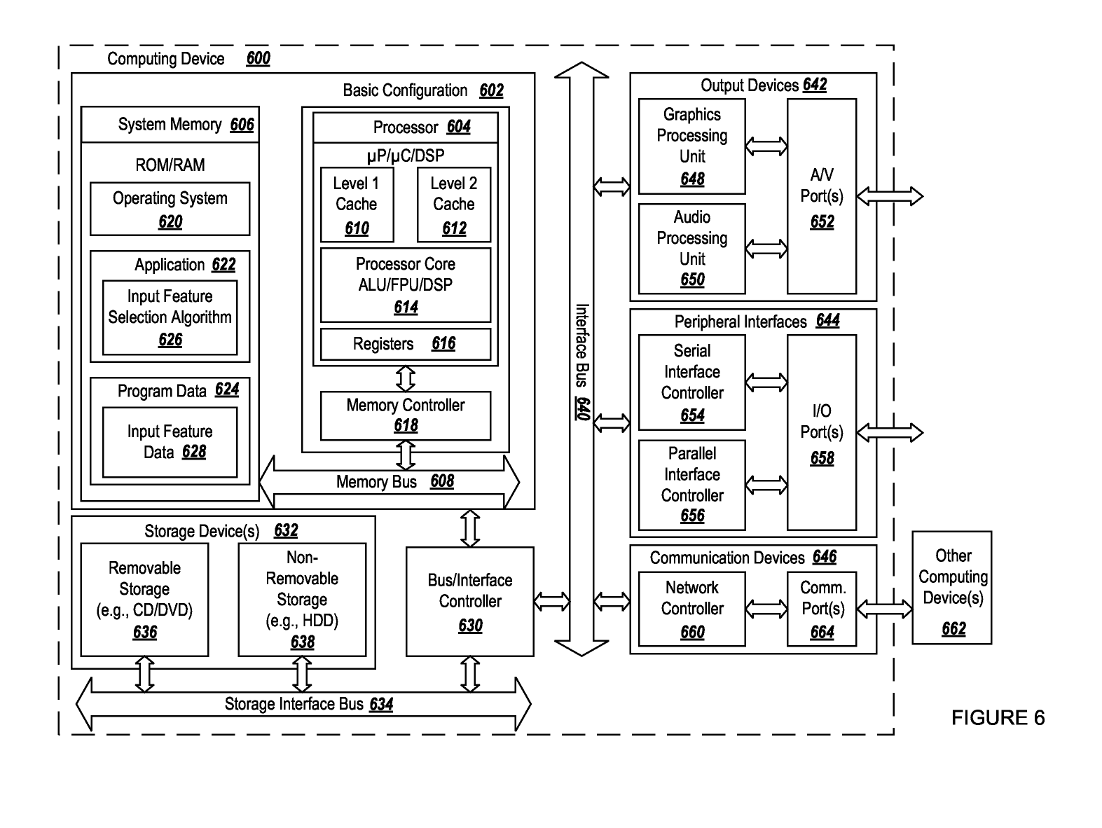

FIG. 6 is a block diagram illustrating an example computing device 600 that is arranged for copula theory-based feature selection, arranged in accordance with at least one embodiment described herein. In a basic configuration 602, the computing device 600 typically includes one or more processors 604 and a system memory 606. A memory bus 608 may be used to communicate between the processor 604 and the system memory 606.

Depending on the desired configuration, the processor 604 may be of any type including, but not limited to, a microprocessor (μP), a microcontroller (μC), a digital signal processor (DSP), or any combination thereof. The processor 604 may include one or more levels of caching, such as a level one cache 610 and a level two cache 612, a processor core 614, and registers 616. The processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including, but not limited to, volatile memory (such as RAM), nonvolatile memory (such as ROM, flash memory, etc.), or any combination thereof. The system memory 606 may include an operating system 620, one or more applications 622, and program data 624. The application 622 may include an input feature selection algorithm 626 that is arranged to perform input feature selection as is described herein. The program data 624 may include input feature data 628 as is described herein, or other input feature data. In some embodiments, the application 622 may be arranged to operate with the program data 624 on the operating system 620 such that the methods 200, 300, 400 and 500 of FIGS. 2, 3, 4 and 5, respectively, may be provided as described herein.

The computing device 600 may have additional features or functionality, and additional interfaces to facilitate communications between the basic configuration 602 and any involved devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 606, the removable storage devices 636, and the non-removable storage devices 638 are examples of computer storage media or non-transitory computer-readable medium or media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by the computing device 600. Any such computer storage media or non-transitory computer-readable media may be part of the computing device 600.

The computing device 600 may also include an interface bus 640 to facilitate communication from various interface devices (e.g., output devices 642, peripheral interfaces 644, and communication devices 646) to the basic configuration 602 via the bus/interface controller 630. The output devices 642 include a graphics processing unit 648 and an audio processing unit 650, which may be configured to communicate to various external devices such as a display or speakers via one or more A/V ports 652. The peripheral interfaces 644 include a serial interface controller 654 or a parallel interface controller 656, which may be configured to communicate with external devices such as input devices (e.g., keyboard, mouse, pen, voice input device, touch input device, etc.), sensors, or other peripheral devices (e.g., printer, scanner, etc.) via one or more I/O ports 658. The communication devices 646 include a network controller 660, which may be arranged to facilitate communications with one or more other computing devices 662 over a network communication link via one or more communication ports 664.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 600 may be implemented as a portion of a small-form factor portable (or mobile) electronic device such as a smartphone, a personal data assistant (PDA), or an application-specific device. The computing device 600 may also be implemented as a personal computer including both laptop computer and non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, various changes, substitutions, and alterations could be made hereto without departing from the spirit and scope of the invention.

What is claimed is:

1. A method comprising:
identifying a first input feature from an input feature set stored in an electronic data storage device;
generating, by a processor, a first copula to model a dependence structure between the first input feature and an output variable;
determining a first dependence degree between the first input feature and the output variable based on the first copula, wherein the input feature set comprises a second input feature with a second dependence degree having a lower value relative to the first dependence degree; and
selecting, by the processor, the first input feature from the input feature set in response to the first dependence degree being greater than the second dependence degree.

2. The method of claim 1 further comprising:
generating a second copula between the first input feature and the second input feature; and
determining the second dependence degree between the second input feature and the output variable based on the second copula.

3. The method of claim 2 further comprising:
adding a third input feature to the input feature set;
generating a third copula between the first input feature, the second input feature and the third input feature;
determining a third dependence degree based on the third copula and the output variable; and
removing the third input feature when the third dependence degree is the same or similar to the first or second dependence degree.

4. The method of claim 1, wherein generating the first copula between the first input feature and the output comprises:
accessing a data storage to identify prior data pertaining to the input feature set; and
generating the first copula between the first input feature and the output variable using a parametric estimation based on the prior data.

5. The method of claim 1, wherein generating the first copula between the first input feature and the output comprises generating the first copula between the first input feature and the output variable using a non-parametric estimation.

6. The method of claim 1, wherein a relationship between the first input feature and the output variable is non-linear, and wherein the first dependence degree is determined by the processor using Kendall's Tau.

7. The method of claim 1, wherein a relationship between the first input feature and the output variable is linear, and wherein the first dependence degree is determined by the processor using Spearman's Rho.

8. A system comprising:
a memory; and
a processing device operatively coupled to the memory, the processing device configured to:
identify a first input feature from an input feature set stored in an electronic data storage device;
generate a first copula to model a dependence structure between the first input feature and an output variable;
determine a first dependence degree between the first input feature and the output variable based on the first copula, wherein the input feature set comprises a second input feature with a second dependence degree having a lower value relative to the first dependence degree; and
select the first input feature from the input feature set in response to the first dependence degree being greater than the second dependence degree.

9. The system of claim 8, the processing device further configured to:
generate a second copula between the first input feature and the second input feature; and
determine the second dependence degree between the second input feature and the output variable based on the second copula.

10. The system of claim 9, the processing device further configured to:
add a third input feature to the input feature set;
generate a third copula between the first input feature, the second input feature and the third input feature;
determine a third dependence degree based on the third copula and the output variable; and
remove the third input feature when the third dependence degree is the same or similar to the first or second dependence degree.

11. The system of claim 8, wherein when generating the first copula between the first input feature and the output, the processing device is configured to:
access a data storage to identify prior data pertaining to the input feature set; and
generate the first copula between the first input feature and the output variable using a parametric estimation based on the prior data.

12. The system of claim 8, wherein when generating the first copula between the first input feature and the output variable, the processing device is further configured to generate the first copula between the first input feature and the output using a non-parametric estimation.

13. The system of claim 8, wherein a relationship between the first input feature and the output variable is non-linear, and wherein the first dependence degree is determined using Kendall's Tau.

14. The system of claim 8, wherein a relationship between the first input feature and the output variable is linear, and wherein the first dependence degree is determined using Spearman's Rho.

15. A non-transitory computer-readable medium having encoded therein programming code executable by a processor to perform or control performance of operations comprising:
identifying a first input feature from an input feature set stored in an electronic data storage device;
generating a first copula to model a dependence structure between the first input feature and an output variable;
determining a first dependence degree between the first input feature and the output variable based on the first copula, wherein the input feature set comprises a second input feature with a second dependence degree having a lower value relative to the first dependence degree; and
selecting the first input feature from the input feature set in response to the first dependence degree being greater than the second dependence degree.

16. The non-transitory computer readable storage medium of claim 15, the operations further comprising:
generating a second copula between the first input feature and the second input feature; and
determining the second dependence degree between the second input feature and the output variable based on the second copula.

17. The non-transitory computer readable storage medium of claim 16, the operations further comprising
adding a third input feature to the input feature set;
generating a third copula between the first input feature, the second input feature and the third input feature;
determining a third dependence degree based on the third copula and the output variable; and
removing the third input feature when the third dependence degree is the same or similar to the first or second dependence degree.

18. The non-transitory computer readable storage medium of claim 15, wherein generating the first copula between the first input feature and the output comprises:
accessing a data storage to identify prior data pertaining to the input feature set; and
generating the first copula between the first input feature and the output variable using a parametric estimation based on the prior data.

19. The non-transitory computer readable storage medium of claim 15, wherein generating the first copula between the first input feature and the output variable comprises generating the first copula between the first input feature and the output using a non-parametric estimation.

20. The non-transitory computer readable storage medium of claim 15, wherein a relationship between the first input feature and the output variable is non-linear, and wherein the first dependence degree is determined using Kendall's Tau.
